(19) United States
(12) Patent Application Publication
(10) Pub. No.: US 2012/0017777 A1
(43) Pub. Date: Jan. 26, 2012

(54) Multifunctional Bread Maker

(76) Inventor: Tony Wang, Guangdong (CN)

(21) Appl. No.: 13/139,971

(22) PCT Filed: Dec. 15, 2009
(86) PCT No.: PCT/CN2009/001442

§ 371 Date: Oct. 4, 2011

(30) Foreign Application Priority Data
Dec. 15, 2008 (CN) 200820205490.9

(51) Int. Cl. A21B 7/00

(52) U.S. Cl. 99/426

(57) ABSTRACT

A multifunctional bread maker, comprises a casing, an oven (41) disposed inside the casing, a door or a cover for closing the oven (41); and further comprises a bread bucket which has an upward opening and is easily loaded and unloaded, more than one set of support device for toasting food; the bread bucket is loaded in a cavity of the oven (41) when it is necessary to use the bread bucket to make bread, and the support device for toasting food is loaded in the cavity of the oven (41) when it is necessary to use the support device for toasting food to toast food; the support device for toasting food comprises a grill and toasting pans (45); and heating elements disposed in the cavity of the oven (41), wherein the heating elements are electrical heating tubes which are disposed around an inner periphery of the cavity of the oven (41); the grill is removably disposed in the cavity of the oven (41); toasting pans (45) are removably disposed on the grill; a baffle (43) for shielding the electrical heating tubes (42) is disposed between the toasting pans (45) and the electrical heating tubes (42); and there is clearance between the baffle (43) and the toasting pans (45), and between the baffle (43) and the electrical heating tubes (42).

### BACKGROUND OF THE INVENTION

1. Technical Field

The present invention relates to a multifunctional bread maker, and more particularly, to a grill of the bread maker for toasting bread in the field of Household Appliances.

2. Description of Related Art

The grill of the bread maker in the prior art comprises an integral and non-detachable shelf and trays with curved cross-section. The shelf and trays of the bread maker with such structures occupy much space when in package and in transit, and they are not convenient for the consumers in storage.

Moreover, the bread maker in the prior art needs to be provided with a grill in the interior of the toasting cavity. The trays are placed on the grill and electrical heating tubes are disposed around the interior of the toasting cavity. Since the electrical heating tubes toast directly the places where the trays are located, heat distribution is uneven, which results in that the bread is burnt partially and the product quality is affected.

### SUMMARY OF THE INVENTION

The present invention is aimed at providing a multifunctional bread maker which makes the oven to be heated evenly and which is simple in structure and convenient for use.

The present invention is achieved by the following technical scheme:

A multifunctional bread maker, comprises a casing, an oven disposed inside the casing, a door or a cover for closing the oven; and further comprises a bread bucket which has an upward opening and is easily loaded and unloaded, more than one set of support device for toasting food; the bread bucket is loaded in a cavity of the oven when it is necessary to use the bread bucket to make bread, and the support device for toasting food is loaded in the cavity of the oven when it is necessary to use the support device for toasting food to toast food; the support device for toasting food comprises a grill and toasting pans; and heating elements disposed in the cavity of the oven, wherein the heating elements are electrical heating tubes which are disposed around an inner periphery of the cavity of the oven; the grill is removably disposed in the cavity of the oven; toasting pans are removably disposed on the grill; a baffle for shielding the electrical heating tubes is disposed between the toasting pans and the electrical heating tubes 42; and there is clearance between the baffle and the toasting pans, and between the baffle and the electrical heating tubes.

In summary, the present invention has following advantages:

In the multifunctional bread maker of the present invention, the heating elements are electrical heating tubes which are disposed around the inner periphery of the cavity of the oven. The grill is removably disposed in the cavity of the oven. The toasting pans are removably disposed on the grill. The baffle for shielding the electrical heating tubes is disposed between the toasting pans and the electrical heating tubes 42. There is clearance between the baffle, the toasting pans and the electrical heating tubes. The heat in the cavity of the oven of the bread maker is transferred evenly, which can protect the bread toasted from being burnt partially.

### BRIEF DESCRIPTION OF THE DRAWING

FIG. 1 is a schematic view illustrating the multifunctional bread maker of the present invention.

### DETAILED DESCRIPTION OF THE PREFERRED EMBODIMENTS

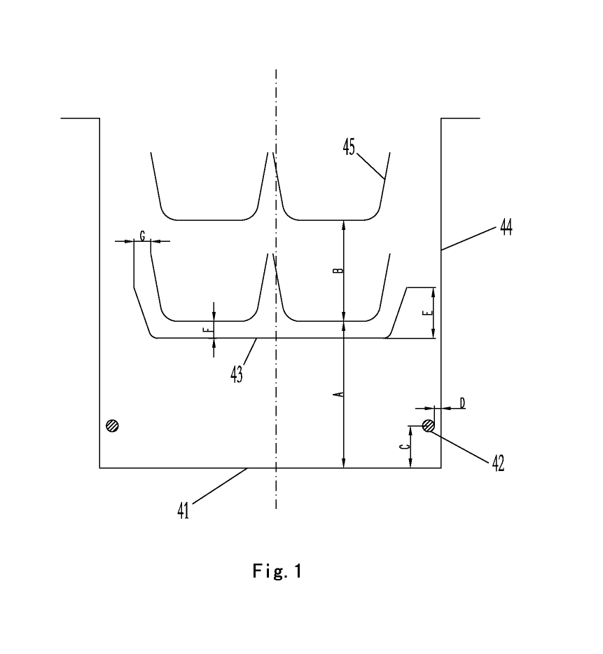

The present invention discloses a multifunctional bread maker which comprises a casing, an oven disposed inside the casing, a door or a cover for closing the oven. The bread maker further comprises a bread bucket which has an upward opening and is easily loaded and unloaded, more than one set of support device for toasting food. The bread bucket is loaded in a cavity of the oven when it is necessary to use the bread bucket to make bread, and the support device for toasting food is loaded in the cavity of the oven when it is necessary to use the support device for toasting food toast food. The support device for toasting food comprises a grill and toasting pans. Heating elements are disposed in the cavity of the oven. As shown in FIG. 1, the heating elements are electrical heating tubes 42 which are disposed around the inner periphery of the cavity of the oven 41. The grill not shown is removably disposed in the cavity of the oven, and the toasting pans 45 are removably disposed on the grill. A baffle 43 for shielding the electrical heating tubes 42 is disposed between the toasting pans 45 and the electrical heating tubes 42. There is clearance between the baffle 43 and the toasting pans 45, and between the baffle 43 and the electrical heating tubes 42.

The grill has at least two levels.

Distance A between the bottom of the lower toasting pan 45 and the bottom of the oven 41 is ranged from 70 mm to 120 mm. Distance C between the electrical heating tubes 42 and the bottom of the oven 41 is ranged from 20 mm to 60 mm. Distance D between the electrical heating tubes 42 and the walls of the oven 41 is ranged from 4 mm to 10 mm. Height E of the wings of the baffle 43 is ranged from 20 mm to 60 mm. Distance B between the bottom of the lower toasting pan and the bottom of the upper toasting pan is ranged from 50 mm to 70 mm. Distance F between the bottom of the lower toasting pan and the baffle 43 is ranged from 5 mm to 15 mm. Horizontal clearance G between the top end of the baffle 43 and the top end of the lower toasting pan is ranged from 5 mm to 10 mm.

Cross-section of the toasting pan is in the shape of a trapezium. Slight fillets are formed between the bottom and sides of the trapezium, and the fillet has a radius less than or equal to 3 mm.

The baffle 43 is heat-insulated.

The preferred embodiments described above are not restricted. It will be understood by those skilled in the art that various modifications and changes may be made therein without departing from the scope of the invention.

1. A multifunctional bread maker, comprising a casing, an oven disposed inside the casing, a door or a cover for closing the oven; and further comprising a bread bucket which has an upward opening and is easily loaded and unloaded, more than one set of support device for toasting food; the bread bucket loaded in a cavity of the oven when it is necessary to use the bread bucket to make bread, and the support device for toasting food loaded in the cavity of the oven when it is necessary to use the support device for toasting food to toast food; the support device for toasting food comprises a grill and toasting pans; and heating elements disposed in the cavity of the oven, characterized in that: the heating elements are electrical heating tubes (42) which are disposed around an inner periphery of the cavity of the oven (41); the grill is removably disposed in the cavity of the oven; toasting pans (45) are removably disposed on the grill; a baffle (43) for shielding the electrical heating tubes (42) is disposed between the toasting pans (45) and the electrical heating tubes (42); and there is clearance between the baffle (43) and the toasting pans (45), and between the baffle (43) and the electrical heating tubes (42).

2. The multifunctional bread maker according to claim 1, characterized in that: the grill has at least two levels.

3. The multifunctional bread maker according to claim 2, characterized in that: distance A between a bottom of a lower toasting pan and a bottom of the oven (41) is ranged from 70 mm to 120 mm; distance C between the electrical heating tubes (42) and the bottom of the oven (41) is ranged from 20 mm to 60 mm; distance D between the electrical heating tubes (42) and walls of the oven (41) is ranged from 4 mm to 10 mm; height E of wings of the baffle (43) is ranged from 20 mm to 60 mm; distance B between the bottom of the lower toasting pan and the bottom of an upper toasting pan is ranged from 50 mm to 70 mm; distance F between the bottom of the lower toasting pan and the baffle (43) is ranged from 5 mm to 15 mm; and horizontal clearance G between a top end of the baffle (43) and a top end of the lower toasting pan is ranged from 5 mm to 10 mm.

4. The multifunctional bread maker according to claim 1, characterized in that: cross-section of the toasting pan is in the shape of a trapezium; slight fillets are formed between a bottom and sides of the trapezium, and the fillet has a radius less than or equal to 3 mm.

5. The multifunctional bread maker according to claim 4, characterized in that: the baffle (43) is heat-insulated.

6. The multifunctional bread maker according to claim 2, characterized in that: cross-section of the toasting pan is in the shape of a trapezium; slight fillets are formed between a bottom and sides of the trapezium, and the fillet has a radius less than or equal to 3 mm.

7. The multifunctional bread maker according to claim 6, characterized in that: the baffle (43) is heat-insulated.

8. The multifunctional bread maker according to claim 3, characterized in that: cross-section of the toasting pan is in the shape of a trapezium; slight fillets are formed between a bottom and sides of the trapezium, and the fillet has a radius less than or equal to 3 mm.

9. The multifunctional bread maker according to claim 8, characterized in that: the baffle (43) is heat-insulated.
